(19) United States
(12) Patent Application Publication
(10) Pub. No.: US 2005/0252318 A1
(43) Pub. Date: Nov. 17, 2005

(54) Apparatus for releasing a jam in a lead screw actuator

(75) Inventor: John M. Corney, London (GB)

Correspondence Address: CROWELL & MORING LLP;INTELLECTUAL PROPERTY GROUP, P.O. BOX 14300, WASHINGTON, DC, 20044-4300, US

(73) Assignee: Bae Systems plc, London (GB)

(21) Appl. No.: 10/509,846

(22) PCT Filed: Aug. 26, 2004
(86) PCT No.: PCT/GB04/03653

§ 371 Date: Oct. 1, 2004

(30) Foreign Application Priority Data
Sep. 5, 2003 (GB) 0320909.5
Sep. 5, 2003 (EP) 03255557.5

(51) Int. Cl. F16H 25/20

(52) U.S. Cl. 74/89.23; 74/89.38

(57) ABSTRACT

Apparatus for releasing a jam between an inter-engaged lead screw (2) and nut (1) in a motor driven lead screw actuator under load includes a device for releasing the jam and a device for operating the jam release device when the normal operating correlation between torque applied to the actuator by the motor (3) and the output force of the actuator corresponding to normal unjammed operation of the actuator under load (4) is lost.

This invention relates to an apparatus for releasing a jam in a lead screw actuator between an inter-engaged lead screw and nut in a motor driven lead screw actuator under load, particularly, but not exclusively, suitable for use in an aircraft.

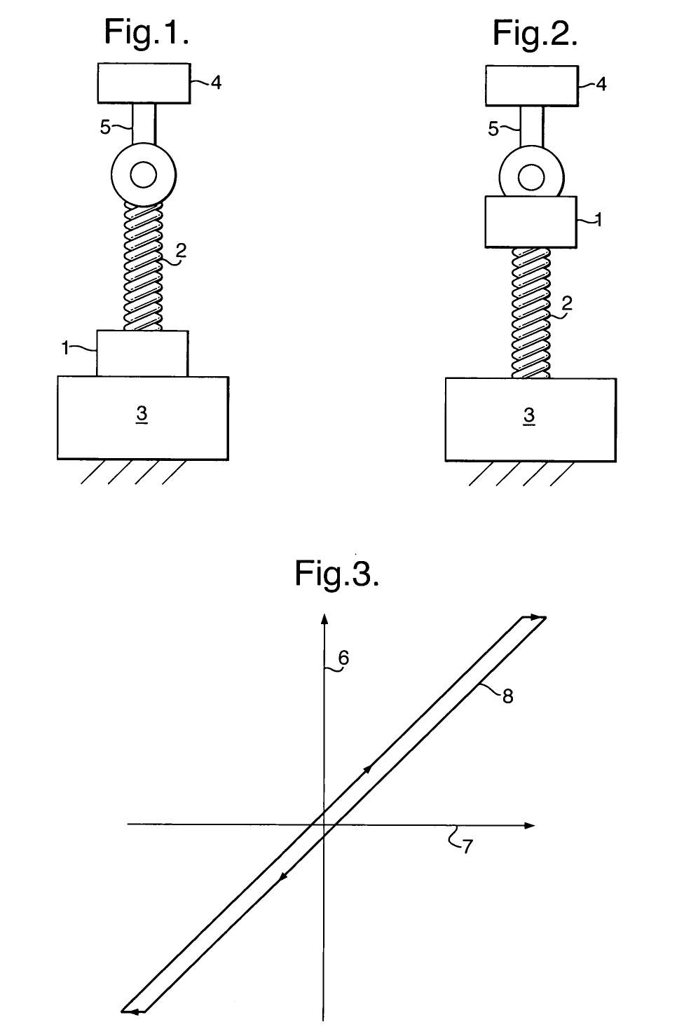

Conventional lead screw actuators (sometimes referred to as screw jacks) as shown in FIGS. 1 and 2 of the accompanying drawings, are a means of exerting a force by causing a nut 1 to turn on a lead screw 2. When a torque is applied to the nut 1 there is a resultant linear force on the lead screw 2 if the latter is prevented from turning with the nut. Alternatively the arrangement may operate in reverse with the torque being applied to the lead screw 2 and the resultant force being exerted on the nut 1 which is prevented from turning. For example in FIG. 1 a motor 3 is shown applying torque to the nut 1 thereby causing it to attempt to move up the lead screw 2. However as the motor 3 and nut 1 are restrained from moving upwards on the lead screw 2 the result is that the lead screw 2 will attempt to move upwards or downwards depending on the direction of the motor torque applied to the nut 1, hence applying a force to a load 4 via an inter-connected linkage 5, which in turn is also designed to prevent the lead screw 2 turning about its longitudinal axis.

In the arrangement shown in FIG. 2 the motor 3 applies torque to the lead screw 2 which thereby applies a force in the vertical direction to the load 4 via the nut 1 which is not free to turn, and the linkage 5.

There is always a possibility of a mechanical jam occurring between the nut 1 and lead screw 2 thereby preventing applied torque from the motor 3 causing a force to be applied to the load 4. In certain applications, particularly within aerospace, it may be unacceptable for an actuator to jam. For example the actuator may be designed correctly to position a control surface such an aileron or elevator, or the swash-plate of a helicopter, and an incorrect position may have critical implications in respect of safety.

It is therefore necessary to design a lead screw actuator for such usages so that not only in normal operation but also under extreme loading conditions, the motor torque does not reach the level at which a conventional torque transmitting disconnect clutch will operate. This means that the motor will need to be significantly more powerful than would be necessary to accomplish its normal actuation task with a consequent impact on size, weight and cost. Another problem with conventional lead screw actuators in aerospace applications is in force-coupled arrangements where two or more actuators are coupled in parallel to a single load such as an aircraft control surface. If one actuator is operating correctly and the other actuator is jammed between its nut and lead screw the result is that whenever a deflection of the control surface is required a force-fight occurs between the two actuators without the required movement of the control surface occurring. Unfortunately under such a force-fight condition it is quite possible that the unjammed actuator will reach its torque threshold first and incorrectly disconnect itself presenting an unsatisfactory and possibly safety critical outcome. A similar situation occurs whenever the number of force-coupled actuators is greater that the number of degrees of freedom of the load. Examples of this include three or more actuators coupled to a two degree of freedom swash-plate and four or more actuators coupled to a three degree of freedom swash-plate as found in helicopters.

There is thus a need for improved apparatus for releasing a jam between an inter-engaged lead screw and nut in a motor driven lead screw actuator under load which does not operate even under high torque conditions in normal non-jammed operation and which can effectively distinguish between an internal jam and external loads.

According to the present invention there is provided apparatus for releasing a jam between an inter-engaged lead screw and nut in a motor driven lead screw actuator under load, including a device for releasing the jam and a device for operating the jam release device when the normal operating correlation between torque applied to the actuator by the motor and the output force of the actuator corresponding to normal unjammed operation of the actuator under load is lost.

In one implementation the jam release device is electro-mechanical and the device for operating the jam release device is electrical.

Conveniently the device for operating the jam release device includes a torque sensor for sensing the torque applied to the actuator, a force sensor for sensing the output force of the actuator, means for comparing the expected normal operating force for a given torque to the actual force at the actual measured torque, and means for actuating the jam release device if the difference between the expected force and the actual measured force is outside a pre-determined threshold and for switching off drive power to the motor.

Advantageously the device for operating the jam release device includes a torque sensor for sensing the torque applied to the actuator, a force sensor for sensing the output force of the actuator, and means for actuating the jam release drive if the sensed force is more positive than a predetermined threshold value T₁ and the sensed torque is more negative than a predetermined threshold value T₃ or if the sensed force is more negative than a predetermined threshold value T₁ and the sensed torque is more positive than a predetermined threshold value T₃, which actuating means is also operable to switch off drive power to the motor.

Preferably the jam release device is an electromagnetic clutch.

Alternatively the jam release device and the device for operating the jam release device are mechanical and combined.

Preferably said devices include two or more spaced apart parallely opposed, cams connectable to the actuator motor in parallel to the lead screw and in drive connection to the motor, at least two spring-loaded finger detents moveably housed one in each cam to project therefrom substantially parallel to one another into the space between the opposed cams, and a peg projecting laterally from the actuator nut for location in the space between the cams to engage between and in contact with both projecting finger detents, so that with the apparatus operatively connected to the actuator and motor and with a load applied to the end of the lead screw remote from the end adjacent to the motor, drive is applied to the lead screw from the motor via the cams attached to the motor, finger detents carried by the cams, and peg attached to the nut, which peg is engaged by and between the finger detents and the angle of the cams being such that the reaction force on the peg under drive from the motor is substantially at right angles to cam faces on the cams, such that if the actuator jams the peg displaces the respective finger detent against the spring-loading and moves out of engagement with the finger detents and cams thereby de-clutching the motor from drive contact with the nut to release the jam.

Alternatively said devices include two or more pairs of oppositely directed spaced apart cam surfaces operatively attached to the circumferential surface of the actuator nut for engagement by spaced apart pairs of drive pegs carried on a tubular member surrounding said nut and spring-loaded in the axial direction of the actuator lead screw carrying the load and screw threadably engaging the nut, which tubular member is axially moveably spring-loadably mounted in an annular surrounding housing in drive contact with the drive motor so that drive is imparted to the nut from the motor via the housing, tubular member, drive pegs and cam surfaces and in the event of a jam the drive pegs are driven along and out of engagement with the cam surfaces with accompanying axial movement of the tubular member against the spring-loading thereby de-clutching motor drive from the nut.

Alternatively the apparatus may include the substitution in which the motor is in driving connection with the lead screw instead of with the nut and the tubular member is connected to the load instead of to the motor.

In yet a further alternative said devices may include two or more spaced apart, parallely opposed, cams driveably connectable to the actuator motor in parallel to the lead screw and interconnected across the space between the cams by a frangible link extending therebetween, and a peg projecting latterly from the actuator nut for location in the space between the cams in engagement with the frangible link, so that with the apparatus operatively connected to the actuator and motor and with a load applied to the end of the lead remote from the end adjacent to the motor, drive is applied to the lead screw from the motor via the cams attached to the motor, the frangible link attached to the cams, and the engaging peg attached to the nut, which frangible link is strong enough to transmit normal torque drive to the nut via the peg but weak enough to shear, and thereby de-clutch the nut from the motor, in a jam situation to release the jam, which cams help to guide the peg as it moves away from its normal operating position after the frangible link has sheared.

Accordingly to a further aspect of the present invention the apparatus is used in an aircraft.

For a better understanding of the present invention, and to show how the same may be carried into effect, reference will now be made, by way of example, to the accompanying drawings, in which;

FIG. 1 is a schematic view of a conventional lead screw actuator not according to the present invention,

FIG. 2 is a diagrammatic illustration of a second version of a conventional lead screw actuator not according to the invention of the present application,

FIG. 3 is a graphical representation of the correlation between applied torque and output force as utilised in the present invention,

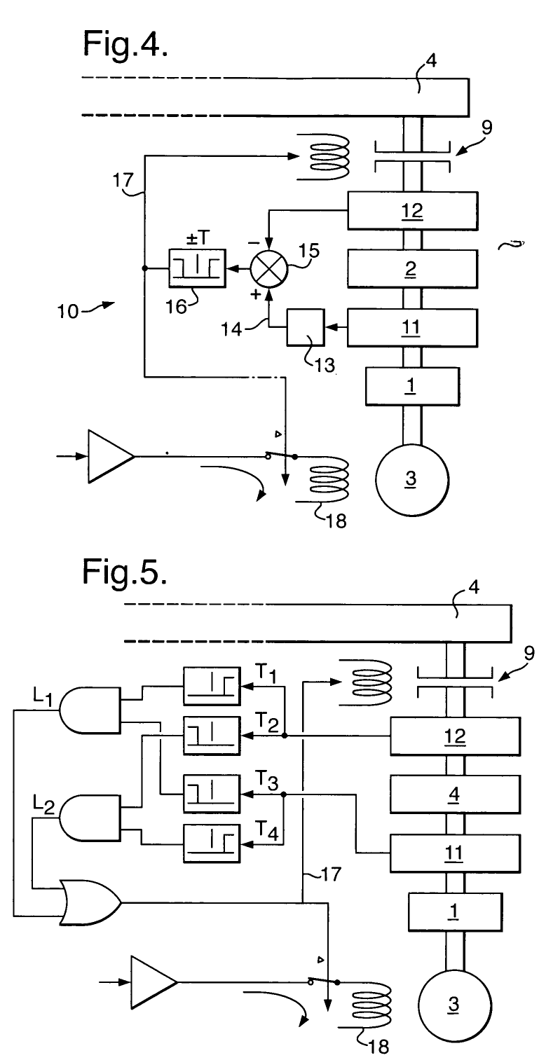

FIG. 4 is a diagrammatic illustration of an electro-mechanical apparatus according to a first embodiment of the present invention for releasing a jam,

FIG. 5 is a diagrammatic illustration of a logic based electro-mechanical apparatus according to a second embodiment of the present invention for releasing a jam,

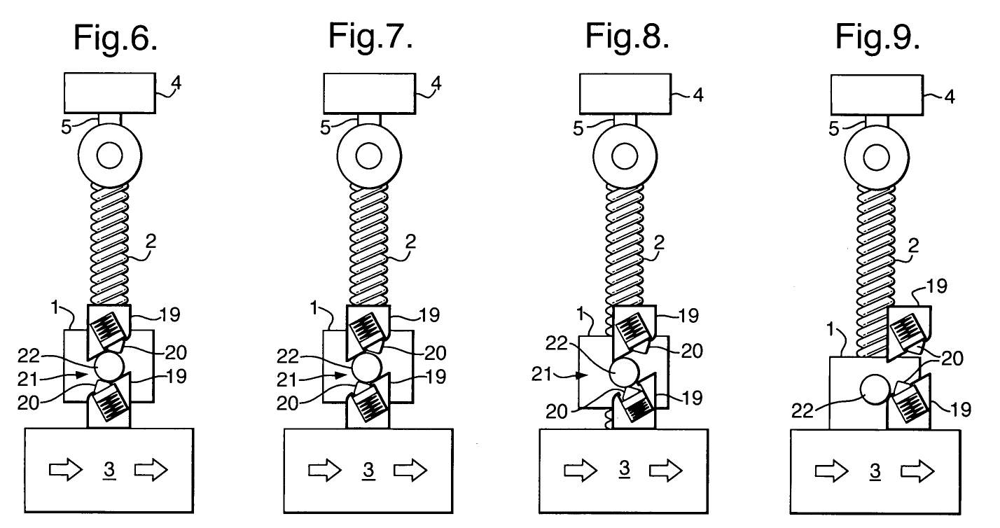

FIGS. 6, 7, 8 and 9 are diagrammatic illustrations of the operating sequence in a jam release apparatus according to a third embodiment of the present invention,

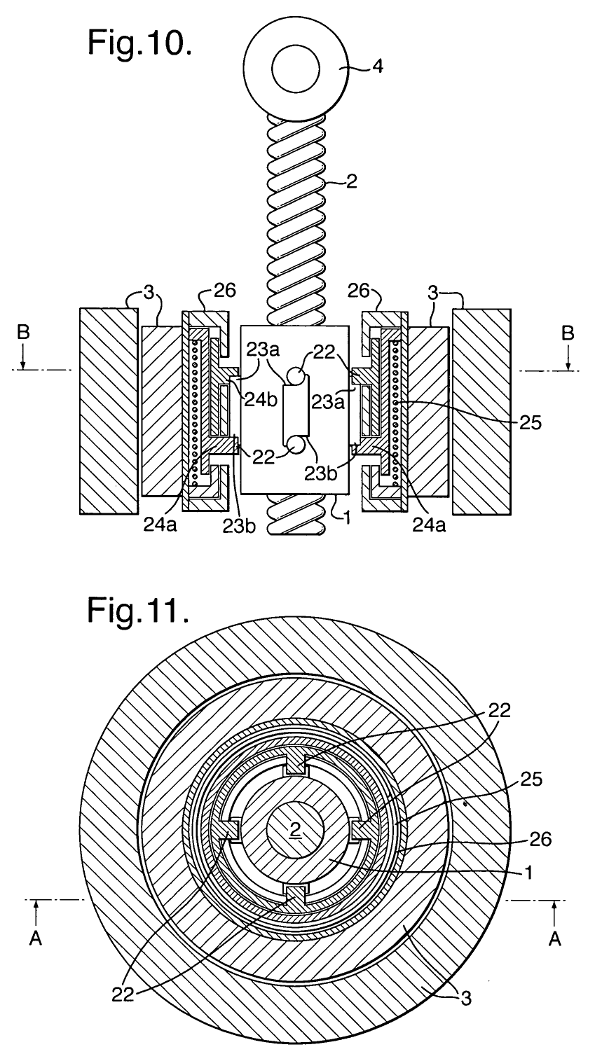

FIG. 10 is a partially sectioned view along the section line AA of FIG. 11 showing a jam release apparatus according to a fourth embodiment of the present invention,

FIG. 11 is a cross-sectional view taken on the line BB of FIG. 10,

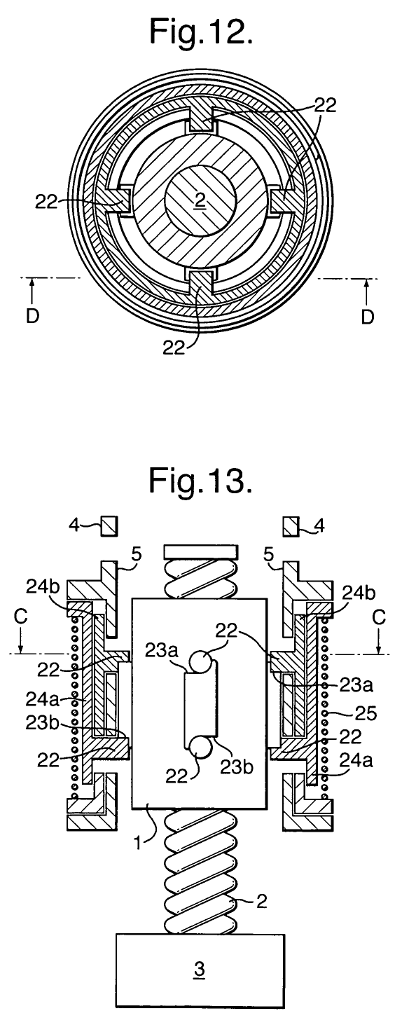

FIG. 12 is a cross-sectional view taken along the line CC in FIG. 13 of a jam release apparatus according to a fifth embodiment of the present invention,

FIG. 13 is a cross-sectional view taken along the line DD in FIG. 12,

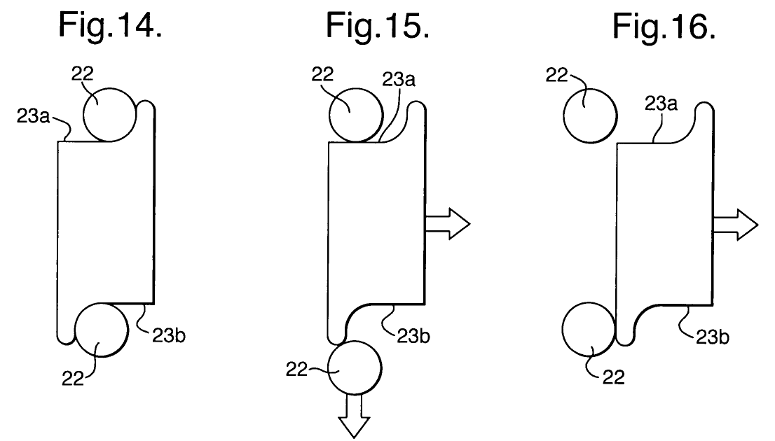

FIGS. 14, 15 and 16 show schematically operating stages for the jam release apparatus of FIGS. 12 and 13,

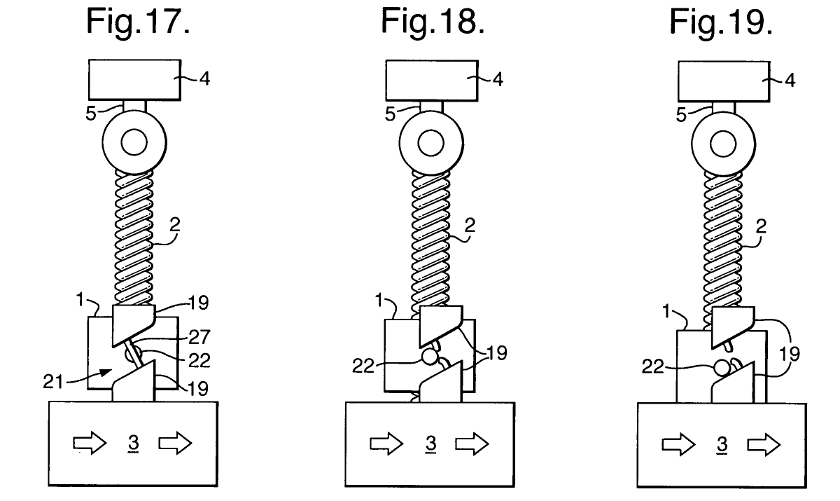

FIGS. 17, 18 and 19 show operating stages for a jam release apparatus according to a sixth embodiment of the present invention,

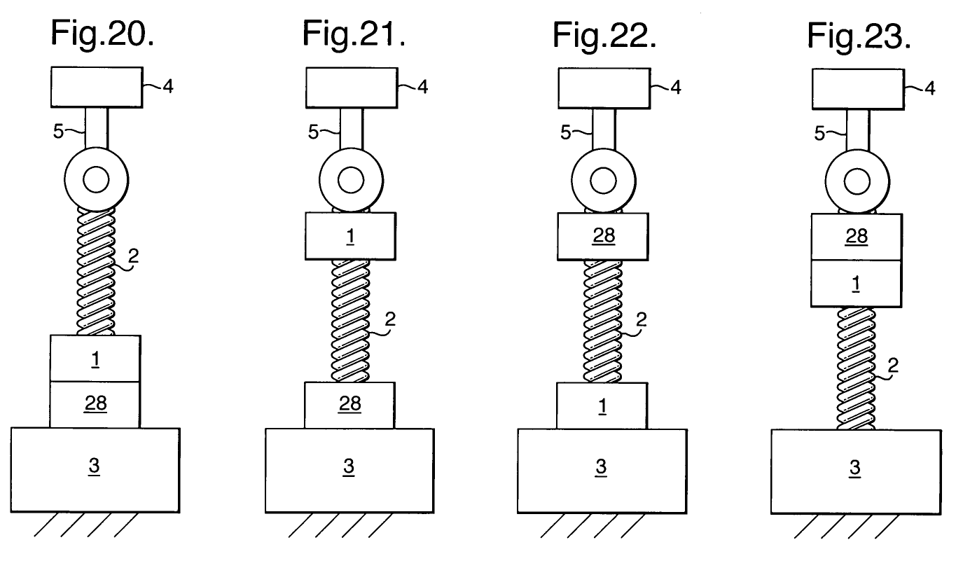

FIGS. 20, 21, 22 and 23 show schematically alternative mounting positions for jam release apparatus according to any one of the embodiments of the present invention.

Apparatus for releasing a jam between an inter-engaged lead screw 2 and nut 1 in a motor driven lead screw actuator under load according to the present invention operates on the application of the correlation of the applied torque from the motor 3 with the resultant linear output force. Assuming very low friction within a correctly functioning lead screw actuator an applied torque will produce an approximately proportional output force as indicated in FIG. 3 of the accompany drawings. FIG. 3 illustrates graphically the relationship between output force 6 and applied torque 7 showing the correlation hysteresis between these two forces under normal operating conditions of the actuator. Any small level of static friction existing within the lead screw actuator will result in the hysteresis characteristic as indicated at 8 but the effect of this minor hysteresis may by ignored. The torque-force correlation of FIG. 3 means specifically that a clockwise torque (defined here as positive as viewed from below and with a right hand threaded screw) will result in a retract (tensile) force (also defined here as positive) while a counter clockwise (negative) torque results in an extend (compressive) force defined here as a negative force. This correlation is no longer maintained if the actuator jams.

In the case of a single lead screw actuator coupled to a load the results of such a jam will be to cause the output force to traverse the horizontal (zero force) axis 7 as the torque is varied throughout its range. In the case of the parallel force-coupled arrangement (not illustrated) the good actuator will follow the normal torque-force relationship shown in FIG. 3 while the jammed actuator will follow an inverse characteristic. The jammed actuator of such a pair will experience an extend (negative) force as positive torque (clockwise torque as observed from below) is applied to each of the actuators. In other words the non-jammed actuator of the pair maintains the correct positive correlation between the applied torque and the force while the jammed actuator maintains a negative correlation. It is this lack of correlation between the applied torque and output force of the jammed actuator that is utilised in the invention of the present application.

FIG. 4 of the accompanying drawings shows an apparatus for releasing a jam between an inter-engaged lead screw 2 and a nut 1 with drive being provided by motor 3. The apparatus includes a device for releasing the jam and a device for operating the jam release device when the normal operating correlation between the torque applied to the actuator by the motor 3 and the output force of the actuator corresponding to normal unjammed operation of the actuator under load 4 is lost. In this embodiment the jam release device is electro-mechanical, preferably in the form of an electromagnetic clutch 9 and the device 10 for operating the jam release device 9 is electrical. The device 10 for operating the jam release device 9 includes a torque sensor 11 for sensing the torque applied to the actuator. A force sensor 12 is provided for sensing the output force of the actuator. As an alternative to the use of the torque sensor 11 a current sensor could be provided.

Means are provided for comparing the expected normal operating force for a given torque to the actual force at the actual measured torque. The implementation described below could equally be carried out by analogue or digital techniques, and it should be noted that the electronic implementation is not the only way. Conveniently the means is in the form a comparator 13 which provides the factor K₁ which is the ratio between the expected force due to a given torque and compares the expected force derived in this way to be compared with the actual measured torque. An output signal 14 is provided in the form a force command to a summer 15 where it is compared with the output signals from the force sensor 12. The summation signal is passed to a further unit 16 where the outputted signal is checked for agreement between the expected force and the actual measured force within a predetermined threshold plus or minus T. If this agreement exists the actuator is considered to be within normal operating tolerances. However if the difference between these quantities exceed this threshold value in either direction then the actuator is deemed to have jammed. At this point a signal is fed through line 17 to the electromagnetic clutch 9 to disengage the latter first to disconnect the actuator from the load 4. At the same time energisation of the motor drive 18 is disconnected thereby stopping the motor 3. This disconnection is not instantaneous. In order to avoid erroneous operation an appropriate time delay or failure count preferably is implemented before the disconnect process is launched within the electronic logic.

A second electro-mechanical apparatus according to the present invention is shown in FIG. 5 in which like parts previously illustrated in FIG. 4 and previously discussed in connection therewith will be given like reference numbers and not described in further detail. This specific embodiment is intended for use with a force-coupled actuator arrangement in which a number of actuators are connected in parallel with a load and in which a jam in one of the actuators produces powerful reverse correlation between torque and force. Thus in the embodiment of FIG. 5 jam release occurs when the correlation between the force and torque is opposite to that which occurs in normal jam-free operation. Jam release occurs when the following logic condition occurs.
Logic L₁. The sensed force is more positive than a predetermined threshold T₁ AND the sensed torque is more negative than a predetermined threshold T₃.
or
Logic L₂. The sensed force is more negative than a predetermined threshold T₁ AND the sensed torque is more positive than a predetermined threshold T₃.

The thresholds are adopted so as to reduce the chance of nuisance jamming release and to allow for some remanent friction during normal operation.

Alternatively the jam release device and the device for operating the jam release device can be mechanical and combined for example as shown diagrammatically in apparatus according to a third embodiment of the present invention as illustrated schematically in FIGS. 6 to 9 of the accompanying drawings. Effectively this embodiment illustrates a mechanical coupling which can only transmit clockwise torque when pulling the load and can only transmit counter-clockwise torque when pushing the load, assuming a right hand thread lead screw. Once again like parts already described in connection with previous embodiments will be given like reference numerals and not described in further detail. In this third embodiment the apparatus according to the invention is installed between the motor 3 and nut 1 where it is subject to both torques and forces. It includes two or more spaced apart parallely opposed, cams 19 connectable to the actuator motor 3 in parallel to the lead screw 2 and in drive connection to the motor 3. At least two spring-loaded finger detents 20 are provided movably housed one in each cam 19 to project therefrom substantially parallel to one another into the space 21 between the cams 19 to engage between and in contact with both projecting finger detents 20. A peg 22 is provided projecting laterally from the actuator nut 1 for location in the space 21 between the cams 19 to engage between and in contact with both projecting finger detents 20. The angle of the cams 19 is such that the reaction force on the peg 22 as the motor 3 drives the nut 1 via the apparatus is nominally at right angles to the face of the cams. Thus the peg 22 will remain midway between the two spring-loaded finger detents 20 regardless of whether the jam release apparatus is being subjected to positive or negative torques and forces.

FIG. 6 shows that for a clockwise torque from the motor 3, as seen from below, movement of the motor in the direction of the arrows thereon there will be a tensile or retract force applied to the load 4. If a jam now occurs between the nut 1 and the lead screw 2 the output force will fall to zero if it is a single actuator or the force will reverse if the actuator is part of a multiple force-coupled actuator arrangement.

FIG. 7 shows the situation when a jam initially occurs. In this condition the force reaction between the cams 19 and peg 22 is no longer at right angles to the line of the faces of the cams 19. This allows relative rotation, clockwise as seen from below, of the cams 19 with respect to the driven peg 22 due to the combination of the clockwise motor torque and the effect of any compressive force reflected from the redundant force coupled actuators if the actuator is used in such an arrangement.

At low departures from the desired torque-force relationship or lack of correlation therebetween the peg 22 remains constrained by the spring-loaded finger detents 20 which define the point at which the jam becomes released. Effectively the peg 22 attached to the jammed nut 1 starts to move downwards against the lowermost detent 20 as the motor torque causes the cams 19 to start to move to the right of FIG. 7. Whereas in FIG. 6 the force on the peg 22 is normal to the faces of the cams 19 in the FIG. 7 situation the force on the peg 22 is no longer normal to the cam faces. Similarly in the FIG. 6 situation tensile force is applied against the external load but in the FIG. 7 situation a compressive force is applied to the load by the jamming actuator. The finger detents 20 define the point at which the jam becomes released. When the detent spring-loading threshold is reached the peg 22 and motor 3 become progressively de-clutched from each other as shown in FIG. 8 of the accompanying drawings. As can be seen from FIG. 8 the peg 22 is at the stage of overcoming the spring-loading of the detent 20 and there has already been significant movement clockwise of the cams 19 and downward movement of the nut 1, lead screw 2 and load 4. As the motor 3 rotates further the peg 22 becomes completely released from the cams 19 and from then on the jam has been completely released as shown in FIG. 9 of the accompanying drawings.

A fourth embodiment of the present invention is illustrated in FIGS. 10 and 11 of the accompanying drawings. In this embodiment the devices include two or more pairs of oppositely directed spaced apart cam surfaces 23a and 23b operatively attached to the circumferential surface of the actuator nut 1. Spaced apart pairs of drive pegs 22 are provided carried on a tubular member surrounding the nut 1 and spring-loaded in the axial direction of the actuator lead screw 2 carrying the load 4 and screw threadably engaging the nut 1. The tubular member is in the form of two tubular parts 24a and 24b with the part 24b being slidably located within the part 24a. The tubular member part 24a is axially movably spring-loadably mounted by a spring 25 in an annular surrounding housing 26 in drive contact with the drive motor 3 so that drive is imparted to the nut 1 from the motor 3 via the housing 26, tubular members 24a and 24b, drive pegs 22 and cam surfaces 23a and 23b. In the event of a jam the drive pegs 22 are driven along and out of engagement with the cam surfaces 23a and 23b with accompanying axial movement of the tubular member 24a and 24b against the loading of the spring 25 thereby de-clutching the motor drive from the nut 1.

A jam release apparatus according to a fifth embodiment of the present invention is shown in FIGS. 12, 13, 14, 15 and 16 of the accompanying drawings. The apparatus of this embodiment the invention is basically the same as that of FIGS. 10 and 11 but in this embodiment the motor 3 drives the lead screw 2 direct which in turn drives the nut 1 which is linked to an external load 4 in the form of a swash-plate via an interconnecting linkage 5. As this embodiment of the invention is basically the same as the embodiment of FIGS. 10 and 11 like parts will be given like reference numbers and not further described in detail. Hence in this embodiment the tubular member 24a and 24b, is connected directly to the load via an annular interconnecting linkage 5.

FIGS. 14, 15 and 16 of the accompanying drawings show the jam release sequence for the embodiment of FIGS. 12 and 13, following incorrect torque-force correlation. This sequence is also applicable to the embodiment of FIGS. 10 and 11. FIG. 14 shows normal operation when there is no jam condition and when the external load is relatively low. Here the pegs 22 are in tight contact with the respective upper and lower cam surfaces 23a and 23b. FIG. 15 shows the situation where there is a jam between the nut 1 and the lead screw 2 while the actuator is trying to pull the load downwards. Here the lower peg 22 in FIG. 15 has also moved downwards by the action of the external forces moving out of contact with the cam surface 23b. The torque reaction from the motor 3 ultimately causes the cam member carrying the cam surfaces 23a and 23b attached to the nut 1 to move to the right in FIG. 16 and to escape from between the pegs 22 into the jam release position shown in FIG. 16.

An alternative apparatus according to a sixth embodiment of the present invention is illustrated diagrammatically in FIGS. 17, 18 and 19 of the accompany drawings. In this apparatus the devices include two or more spaced apart, parallely opposed, cams 19 as in previous embodiments which cams 19 are driveably connected to the actuator motor 3 in parallel to the lead screw 2. The cams 19 are interconnected across the space 21 between the cams by a frangible link 27 extending therebetween which acts as a shear link. A peg 22 projecting laterally from the nut 1 as can be seen particularly in FIG. 18 is located in the space 21 in engagement with the frangible link 19. To this end the peg 22 may actually be formed integrally with the link 27 or just be in engagement therewith. The link 27 has directional characteristics. This means that it is relatively strong in the direction of normal operation of the actuator but relatively weak in the direction that occurs under a jam condition. Thus FIG. 17 shows the normal operating condition in which the combination of torque and reaction to the actuator output load is transmitted along the strong axis of the link 27 into its attachment to the nut 1 via the peg 22. The link is designed to be adequately strong in this diagonal direction to support the highest loads likely to be encountered in normal operation of the linear actuator.

In the event of a jam between the nut 1 and the lead screw 2 the force between the motor 3 and the attachment of the link 27 to the nut 1 via the peg 22 will no longer be along the strong axis of the link 27. The result is that large forces will be applied along the weak axis resulting in the shearing of the link 27 and the release of the jam as shown in FIG. 18. FIG. 18 shows this shearing process as a result of the motor torque being applied laterally with respect to the drawing without there being any actuator load to move the nut in a vertical axis. This condition applies when a jam occurs as the actuator is attempting to move the load downwards but there is no significant output force.

FIG. 19 shows the continuation of this shearing process and the jam release when the jammed actuator is one of a set of two or more force-coupled actuators. In this case the effects of the other actuators which are operating correctly is to try to force the jammed actuator to retract thus augmenting the motor torque in the jam release process which results in the nut 1, lead screw 2 and load 4 all moving downwardly whilst the motor 3 rotates in a clockwise direction as seen from below in FIG. 19. In this embodiment the opposing parallel cams 19 only come into effect after the frangible links 27 have become disconnected by the jam forces, at which stage they help to guide the peg 22 as it moves away from its normal operating position.

The jam release apparatus according to the present invention may be located in various ways relative to a load 4, motor 3, lead screw and nut 1. For example in the accompanying FIG. 20 the motor 3 drives the nut 1 via a jam release apparatus 28 according to the present invention. In FIG. 21 the motor drives the lead screw 2 via a jam release apparatus 28 according to the present invention and the nut 1 is coupled to the load 4 via the interconnecting link 5. In the FIG. 22 arrangement the motor 3 drives the nut 1 directly with the jam release apparatus according to the present invention being coupled directly to the load 4 via the interconnecting link 5. Finally in the arrangement of FIG. 23 the motor 3 drives the lead screw 2 whilst the nut 1 is connected to the load 4 via a jam release apparatus 28 according to the present invention and the interconnecting link 5. It is to be understood that apparatus for releasing a jam between inter-engaged lead screw and nut in a motor driven load screw actuator under load according to the present invention may be employed in any one of the ways shown in FIGS. 20, 21, 22 and 23 of the accompanying drawings. The arrangement of FIG. 22 is preferred because the jam release apparatus 28 does not rotate with the motor 3 in normal operation of the actuator. This means that it is easier to monitor in aerospace applications such as in flight on an aircraft. In the FIG. 22 arrangement the jam release apparatus 28 is physically separate from the motor 3 and nut 1 which simplifies operation. In the arrangements of FIGS. 20 and 21 the jam release apparatus 28 is subject to the applied motor torque and to the actuator end loads. In the arrangements of FIGS. 22 and 23 the jam release apparatus 28 is subject to both the actuator force and the torque reaction.

It is to be understood that the apparatus of the present invention as described herein is particularly suitable for aerospace applications such as for correctly positioning a control surface such as an aileron or elevator or the swash-plate of a helicopter.

1. An apparatus for releasing a jam between an inter-engaged lead screw and nut in a motor driven lead screw actuator under load, including a device for releasing the jam and a device for operating the jam release device when the normal operating correlation between torque applied to the actuator by the motor and the output force of the actuator corresponding to normal unjammed operation of the actuator under load is lost.

2. Apparatus according to claim 1, wherein the jam release device is electro-mechanical and wherein the device for operating the jam release device is electrical.

3. Apparatus according to claim 2, wherein the device for operating the jam release device includes a torque sensor for sensing the torque applied to the actuator, a force sensor for sensing the output force of the actuator, means for comparing the expected normal operating force for a given torque to the actual force of the actual measured torque, and means for actuating the jam release device if the difference between the expected force and the actual measured force is outside a predetermined threshold and for switching off drive power to the motor.

4. Apparatus according to claim 2, wherein the device for operating the jam release device includes a torque sensor for sensing the torque applied to the actuator, a force sensor for sensing the output force of the actuator, and means for actuating the jam release drive if the sensed force is more positive than a predetermined threshold value T1 and the sensed torque is more negative than a predetermined threshold value T3 or if the sensed force is more negative than a predetermined threshold value T1 and the sensed torque is more positive than a predetermined threshold value T3, which actuating means is also operable to switch off drive power to the motor.

5. Apparatus according to claim 2, wherein the jam release device is an electromagnetic clutch.

6. Apparatus according to claim 1, wherein the jam release device and the device for operating the jam release device are mechanical and combined.

7. Apparatus according to claim 6, wherein the said devices include two or more spaced apart parallely opposed, cams connectable to the actuator motor in parallel to the lead screw and in drive connection to the motor, at least two spring-loaded finger detents moveably housed one in each cam to project therefrom substantially parallel to one another into the space between the opposed cams, and a peg projecting laterally from the actuator nut for location in the space between the cams to engage between and in contact with both projecting finger detents, so that with the apparatus operatively connected to the actuator and motor and with a load applied to the end of the lead screw remote from the end adjacent to the motor, drive is applied to the lead screw from the motor via the cams attached to the motor, finger detents carried by the cams, and peg attached to the nut, which peg is engaged by and between the finger detents, and the angle of the cams being such that the reaction force on the peg under drive from the motor is substantially at right angles to cam faces on the cams, such that if the actuator jams the peg displaces the respective finger detent against the spring-loading and moves out of engagement with the finger detents and cams thereby de-clutching the motor from drive contact with the nut to release the jam.

8. Apparatus according to claim 6, wherein said devices include two or more pairs of oppositely directed spaced apart cam surfaces operatively attached to the circumferential surface of the actuator nut for engagement by spaced apart pairs of drive pegs carried on a tubular member surrounding said nut and spring-loaded in the axial direction of the actuator lead screw carrying the load and screw threadably engaging the nut, which tubular member is axially movably spring loadably mounted in an annular surrounding housing in drive contact with the drive motor so that drive is imparted to the nut from the motor via the housing, tubular member, drive pegs and cam surfaces and in the event of a jam the drive pegs are driven along and out of engagement with the cam surfaces with accompanying axial movement of the tubular member against the spring-loading thereby de-clutching motor drive from the nut.

9. Apparatus according to claim 8, including the substitution in which the motor is in driving connection with the lead screw instead of with the nut, and the tubular member is connected to the load instead of to the motor.

10. Apparatus according to claim 6, wherein said devices include two or more spaced apart, parallely opposed, cams driveably connectable to the actuator motor in parallel to the lead screw, and interconnected across the space between the cams by a frangible link extending therebetween, and a peg projecting laterally from the actuator nut for location in the space between the cams in engagement with the frangible link, so that with the apparatus operatively connected to the actuator and motor and with a load applied to the end of the lead screw remote from the end adjacent to the motor, drive is applied to the lead screw from the motor via the cams attached to the motor, the frangible link attached to the cams, and the engaging peg attached to the nut, which frangible link is strong enough to transmit normal torque drive to the nut via the peg but weak enough to shear, and thereby de-clutch the nut from the motor, in a jam situation to release the jam, which cams help to guide the peg as it moves away from its normal operating position after the frangible link has sheared.

11. Apparatus according to claim 1, when used in an aircraft.

12. (canceled)
